(19) United States
(12) Patent Application Publication
(10) Pub. No.: US 2007/0186453 A1
(43) Pub. Date: Aug. 16, 2007

(54) SOUVENIR TOILETRY ARTICLE, INCLUDING A TOOTHBRUSH, FLOSSER, HAIR COMB OR HAIR BRUSH

(76) Inventors: Gary Little, West Dundee, IL (US); Samuel Gomon, Glenview, IL (US); Vladimir Gekhter, Skokie, IL (US)

Correspondence Address: SCHIFF HARDIN, LLP;PATENT DEPARTMENT, 6600 SEARS TOWER, CHICAGO, IL, 60606-6473, US

(21) Appl. No.: 11/736,029

(22) Filed: Apr. 17, 2007

Related U.S. Application Data
(63) Continuation-in-part of application No. 11/002,020, filed on Dec. 2, 2004.

(51) Int. Cl. A46B 5/02; A45D 24/00; A45D 24/10; A46B 11/00; G09F 3/00; A61C 15/00

(52) U.S. Cl. 40/314; 15/143.1; 132/311; 132/323; 132/147; 132/148

(57) ABSTRACT

A souvenir toiletry article includes a handle part made with clear thermoplastic material, a molded pocket inside the clear handle for placement inside of this pocket with a flat or shaped insert having printing or an image on one or both side images, a clear or opaque molded insert located inside the molded pocket on the top of the printed insert and a soft spongy part of the toothbrush molded to the handle of the toothbrush for convenient gripping of the handle by a user. A hair comb, brush, flosser, and other toiletry articles are also considered that have a similar handle design.

### CROSS-REFERENCE TO RELATED APPLICATIONS

This application is a continuation-in-part of parent application Ser. No. 11/002,020, filed Dec. 2, 2004. The parent application is herein incorporated by reference.

### BACKGROUND

The present invention is directed to a toothbrush or other toiletry article that provides a unique combination of utility and aesthetics. Existing methods of applying applications on such article handles includes the use of decals, ink imprinting, laser imprinting, and labels applications. Concerning toothbrushes, since toothpaste is an aggressive and abrasive substance, it is common that after using the toothbrush several times, the applications come off partially or entirely. It is desirable to provide applications, such as images and or text/logos, that will durably remain on the toothbrush despite heavy use around abrasive substances. Although a flosser, hair comb or brush is not normally surrounded by or used in conjunction with such abrasive substances, repeated use and contact by oily skin can produce a similar wearing of any applications that may be provided.

It is known in the art to provide a form of display or artwork on or in the handle of a toothbrush. However, such designs are problematic because they fail to adequately seal against liquids. Over time, liquids can enter into the image area and ruin the display of the images.

### SUMMARY

The present design for a toothbrush, flosser, hair comb or brush provides a unique combinations of materials, applications, and colors that create very attractive and vivid products. Advantageously, the multi-color application stays inside of the handles and never comes into contact with aggressive toothpastes products or skin oils remains at the original quality for the duration of the products usage. This is achieved by a toothbrush comprising: a head portion comprising extruded and end-rounded bristles; a handle part comprising a thermoplastic material and further comprising an image pocket; an image insert comprising text or an image on one or both sides that is located within the image pocket; a pocket insert (optional) placed inside of the image pocket on top of the image insert; and a soft rubber-like material molded to the handle. The thermoplastic material tightly seals the interior portion, specifically including the image pocket, in order to prevent liquids from contacting or accumulating in the image pocket.

Various embodiments of the invention include those having an interchangeable insert of different colors with different messages molded on the top of the insert. Space between the letters of the insert and pockets on the surface of the toothbrushes may filled with a soft rubber-like material for a comfortable grip users of these products. Toothbrushes or other toiletry articles of this design can deliver many messages to the users, improve mood in the morning with images such as cats, dogs or pictures of favorite places such as parks, buildings, mountings, rivers, sports and games and so on and decorate the bathroom with high quality colorful products. They can also be used for advertisement purposes.

According to an embodiment, a toothbrush and other toiletry articles is provided with a clear handle for the article, with a picture insert visible through a clear window of the handle. A plastic insert covers the picture insert and a thermoplastic material covers a gap between the plastic insert, handle, and pockets for the grip area. In an embodiment, the insert was molded in separate mold and requires a special assembly operation with the clear handle.

However, according to a further embodiment, the technology for manufacturing toothbrushes and other toiletry articles may be achieved with pictures visible through the clear window of the article handles where a plastic insert covering the picture insert molded directly into the toothbrush handle without being separately formed and requiring a separate insertion step after its formation and covers the picture insert in a second molding operation. A thermoplastic elastomer material covers the gap between the plastic insert, handle, and pockets for the grip area molded in a third molding operation. This technology significantly decreases the cost of operation, provides reliable part design, and significantly reduces or eliminates the possibility of disassembling the articles during usage.

### BRIEF DESCRIPTION OF THE DRAWINGS

Various embodiments of the invention are described below with reference to the following drawing figures.

FIG. 1 is longitudinal section view through the molded and assembled toothbrush product;

FIG. 2 is a top view of the toothbrush with plastic insert and over molded soft rubber-like material;

FIG. 3 is a bottom view of the toothbrush with picture insert visible through the bottom part of the clear handle and molded rubber pad for the thumb;

FIG. 4 is a top view of the clear handle with pocket for the inserts, molded gate area, pocket for the rubber-like material and gap for passage the molded rubber-like material from the upper part of the handle to the lower part of the handle;

FIG. 5 is a longitudinal section view of the clear handle with pocket for the inserts, step for redirecting the stream of rubber-like material during injection of this material inside the cavity and preventing the printing image from disturbance by the flow of plastic, and pockets for rubber-like material;

FIG. 6 is a cross-sectional view perpendicular to the longitudinal section of the toothbrush handle and showing the convex shape of the handle;

FIG. 7 is a cross-sectional view perpendicular to the longitudinal section of the toothbrush handle and showing the flat shape of the handle;

FIG. 8 is a cross-sectional view perpendicular to the longitudinal section of the toothbrush handle and showing the concave shape of the handle;

FIG. 9 is plastic insert side view;

FIG. 10 is plastic insert top view;

FIG. 11 is another embodiment of the toothbrush with a two-sided image flat inset and clear material injected on the top of the two-sided image flat insert and all pockets filled in the clear handle;

FIG. 12 is top view of this embodiment illustrating the image that is clearly seen through the clear plastic injected in the pocket of clear handle;

FIG. 13 is bottom view of the same handle;

FIG. 14 is another embodiment of the toothbrush with a plastic insert placed on the top of the flat insert with pictures placed on opposite sides of the insert and other pockets in the handles filled with a rubber-like material;

FIG. 15 is side view of this clear insert;

FIG. 16 is top view of this flat insert;

FIG. 17 is a cross-sectional view of the handle at the insert position and showing the soft rubber-like material in a wrap-around configuration;

FIG. 18 is a side view of an alternate embodiment of the insert as illustrated in FIG. 9, having locking mechanisms built in;

FIG. 19 is a top view of an embodiment of a comb having an insert with raised lettering;

FIG. 20 is a top view of an embodiment of a comb having an insert with images or alternately a bottom view of the embodiment of FIG. 19;

FIG. 21 is an embodiment of a brush showing a handle having an insert with raised lettering;

FIG. 22 is an embodiment of a brush showing a handle having an insert with images;

FIG. 23 is a top view of an embodiment of a flosser;

FIG. 24 is a top view of a knob on the flosser;

FIG. 25 is a side view of the knob shown in FIG. 24;

FIG. 26 is an enlarged view of the friction teeth illustrated in FIG. 24;

FIG. 27 is a side view of an embodiment of the ribbed area having protrusions;

FIG. 28 is a top view of the embodiment shown in FIG. 27;

FIG. 29 is a top view of a clear toothbrush handle according to a further embodiment after a fist shot molding;

FIG. 30 is a side view of the clear toothbrush handle after the fist shot molding illustrating two windows for passing thermoplastic elastomer material from the top part of the toothbrush handle to bottom part of the toothbrush handle in the grip area;

FIG. 31 show pictorial illustrations of different options for a company's logo or trade marks;

FIG. 32 is a side view of the clear toothbrush handle after a first molding operation with option of one window for passing thermoplastic elastomer material from the top portion of the toothbrush to bottom part of the toothbrush in grip area;

FIG. 33 is a side view of the clear handle with a picture insert;

FIG. 34 is a side view of the clear handle with a molded plastic insert over picture insert;

FIG. 35 is a side view of the completely molded toothbrush handle with thermoplastic elastomer material molded over plastic insert;

FIG. 36 is a view of the completely molded toothbrush handle from the bristles side of the toothbrush handle; and

FIG. 37 is a view of the completely molded toothbrush handle from the logo side opposite bristles side of the toothbrush handle.

### DETAILED DESCRIPTION OF THE PREFERRED EMBODIMENTS

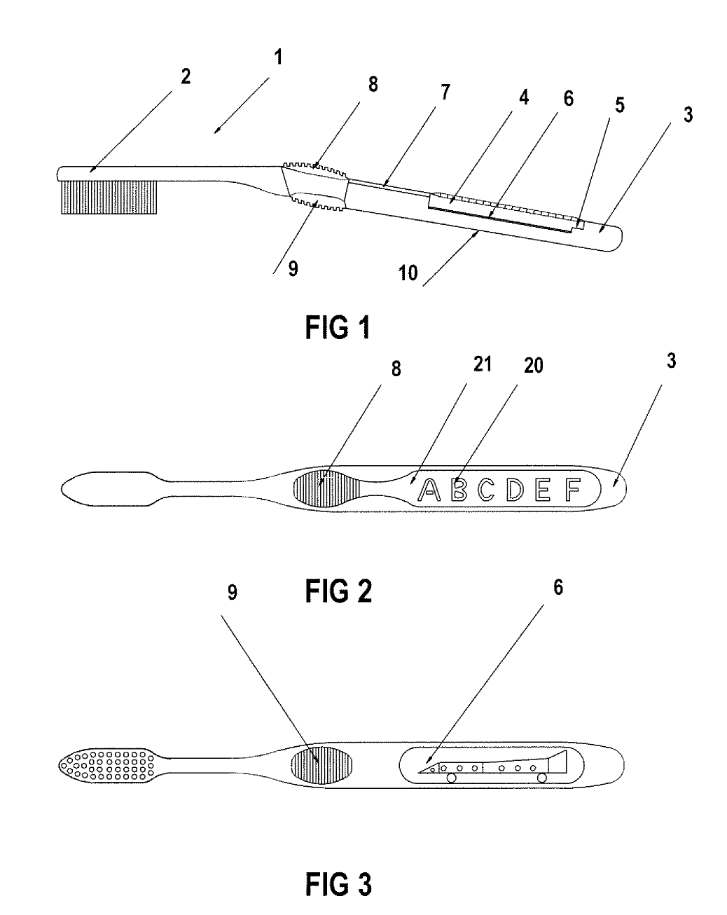

According to an embodiment of the invention illustrated in the Figures, FIG. 1 depicts a longitudinal section view through a molded and assembled toothbrush. A toothbrush 1 has head portion 2 that contains the bristles of the toothbrush 1, a handle part 3 that is gripped by a user when brushing his or her teeth, a plastic pocket insert 4 that fills in a pocket 5 in the handle 3 having a gate area of a soft rubber-like material such as thermoplastic elastomer (TPE) or other similar material that is often used on toothbrush handles to ensure a solid grip and for aesthetic reasons. A picture insert 6 having a graphic illustration is disposed in the bottom of the pocket area 5 and is covered by the plastic pocket insert 4. The pocket insert 4 may be made of a clear, translucent, or opaque material.

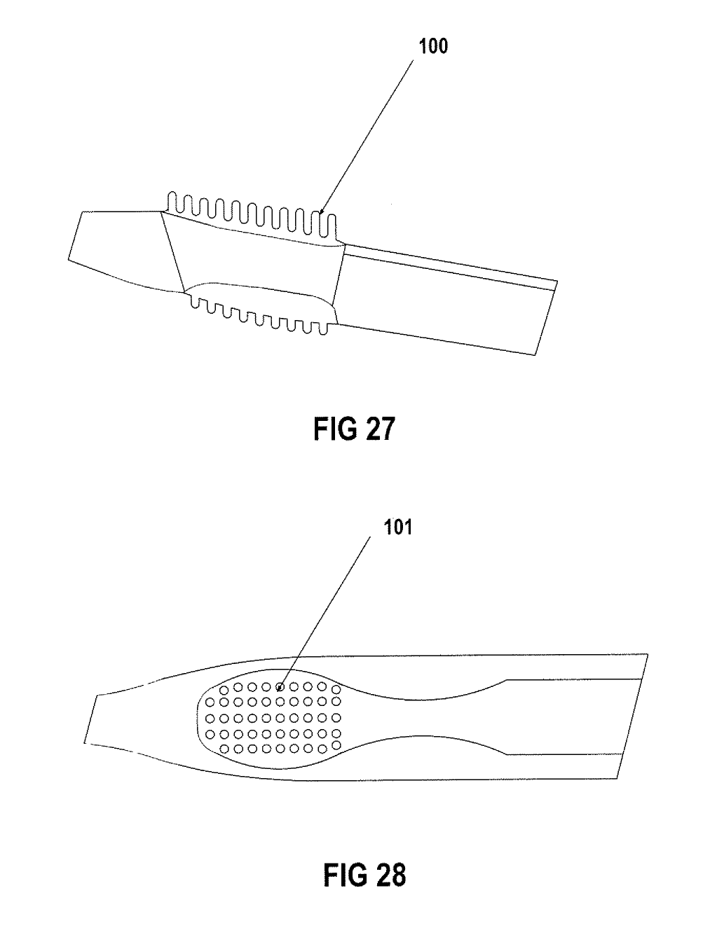

A pocket bridge 7 is filled with the soft rubber-like material that lies between the plastic insert 4 area and a ribbed area 8, 9. The ribbed area 8, 9 has a portion on a top part 8, and a ribbed area on a bottom part 9 of the toothbrush 1 for contact with a user's thumb that is filled with the soft rubber-like material. FIGS. 27 and 28 show an alternate embodiment in which the ribbed area 101 comprises a plurality of protrusions 100. The handle part may comprise a finger grip for the ribbed area of which a portion is on a top part of the handle part, and another portion is on a bottom part of the handle part, the finger grip portion comprising the soft rubber-like material. In an embodiment, the length of at least some of the protrusions is greater than a distance separating center points of the protrusions. In another embodiment, the length of the protrusions on a top side of the toiletry article differ from a length of the protrusions on a bottom side of the toiletry article.

The image area 10 is present on the bottom part of the toothbrush 1 and is clear so that the picture insert 6 can be seen when viewing the brush from the bottom side.

FIG. 2 shows a top view of the toothbrush 1 having molded letters 20 on the top of the inserts, which can represent, e.g., a logo or company name. These letters 20 may be surrounded by the soft rubber-like material 21 and may project above, be level with, or slightly depressed from the surface of this soft material 21.

FIG. 3 shows a bottom view of the toothbrush 1 with picture 6 visible through the clear handle of the toothbrush. The handle 3 may be made of a clear or translucent plastic material, or only portions of the handle 3 may be clear or translucent such that ambient light can provide illumination to the picture 6.

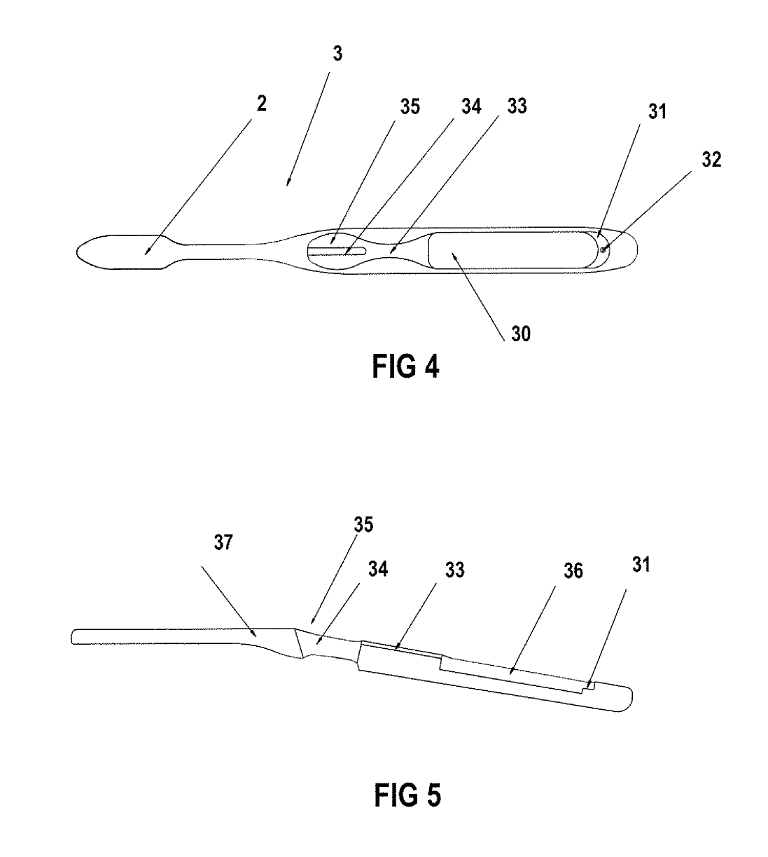

FIG. 4 is a top view of e.g., the clear handle 3 prior to the bristles being added (bristle holes not shown). A bottom portion of the pocket for the gate 31 holds the injected rubber-like material that is above the bottom of the pocket 30 for the plastic insert. This configuration prevents a disturbance of the flat picture insert 6 in the case where the rubber-like material is directly molded without the plastic insert installed. An identified position 31 indicates the location of the gate 32 for the rubber-like material. A pocket for the bridge 33 connects the pocket 35 for the rubber-like material. The rubber-like material is designed so that it is held firmly in place on the handle 3, with the use of through-channels, inversely tapered holes, shrinkage, or the like.

FIG. 5 is a longitudinal cross-section view of the clear handle 3. The pocket 36 is connected through the bridge 33 with the pocket 35. A gap (34, FIG. 4) may be placed on the bottom of pocket 35 which connects upper and lower pockets in the handle 3 for the rubber-like material with ribbed areas (8, 9, FIG. 1) and keeps the ribbed areas 8, 9 connected together and affixed to the handle.

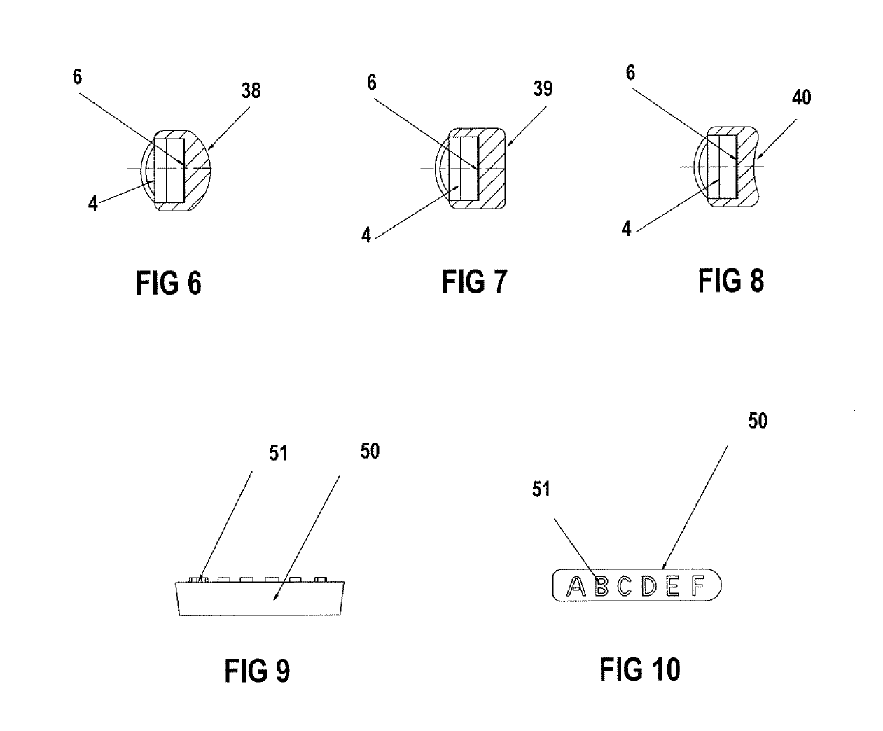

Various cross-sectional shapes of the clear handle 3 may be provided to enhance the picture 6 in various ways. FIG. 6 is a cross-sectional view perpendicular to the longitudinal section of the toothbrush 1 having a convex shape 38 of the handle 3. Such a convex shape 38 creates a magnifying effect on the picture 6 disposed therein. FIG. 7 is a cross-sectional view perpendicular to the longitudinal section of the toothbrush 1 having a flat shape 39 of the handle 3. In this configuration, the distortion/lensing effect is minimized, thereby presenting an accurate sized view of the picture 6 disposed therein. FIG. 8 is a cross-sectional view perpendicular to the longitudinal section of the toothbrush 1 having a concave shape 40 of the handle 3. Such a concave shape 40 creates a shrinking effect on the picture 6 disposed therein.

FIG. 9 is a side view of a plastic insert 50 having embossed letters 51 on a top surface of the insert. FIG. 10 is a top view of this plastic insert 50 illustrating these letters 52.

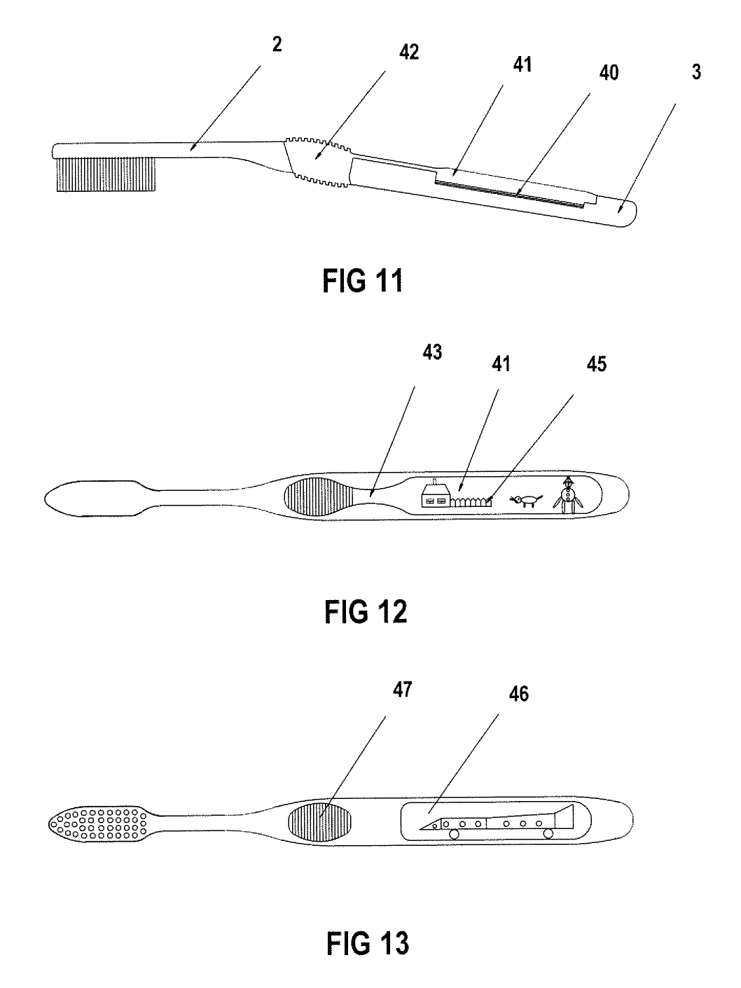

FIG. 11 is another embodiment of the toothbrush 1 with two images placed on two sides of the insert 40. This design has clear handle 3 filled with a clear material 41 in the pocket area of the clear handle and in the ribbed pocket area 42.

FIG. 12 is top view of this embodiment. A first image 45 present on one side of the insert 40 is clearly seen through the clear material 41 molded into the handle 3. Clear material fills rest of the pocket in the handle 3 through bridge 43.

FIG. 13 is bottom view of the same handle with a second image 46 seen through the clear handle 3. The pocket 30 in the clear handle 3 (FIG. 4) is not symmetrical. This design eliminates a possible mistake in placement of the insert with picture 46 into the pocket of clear handle 3. The non-symmetry may lie about an axis defining the length of the brush, its width, or its height—this non-symmetry can be used for visual aesthetic purposes as well as to assist in the assembly of the device.

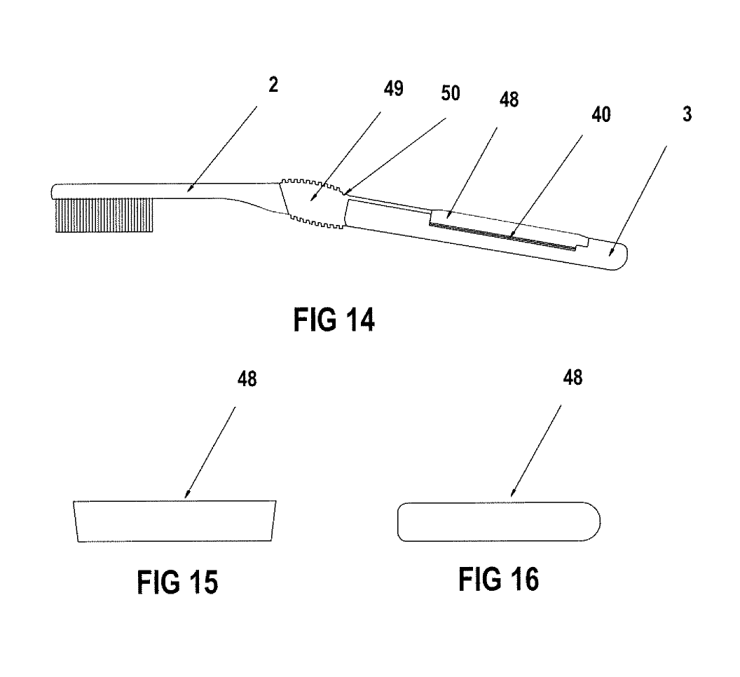

FIG. 14 is another embodiment of the toothbrush 1 with a plastic insert 48 placed on the top of the flat insert 40 having pictures on two opposite sides of the insert 40. This toothbrush design has part of the handle 3 filled with soft rubber-like material 49. In this case, gate 50 for injecting the soft rubber-like material into the clear handle is moved further up the handle closer to the bristle portion to the location indicated by reference character 50 on in FIG. 14. FIG. 15 is a side view of the plastic insert 48 illustrating a truncated tapered shape that may be used, e.g., to assist in the insertion into the handle 3. FIG. 16 is a top view of the plastic insert 48 having an exemplary shape to match the pocket of the handle. Such a non-symmetrical design of the insert 48 can help to eliminate a mistake in the placement of this plastic insert 48 and insert with picture 46 into the pocket of clear handle 3.

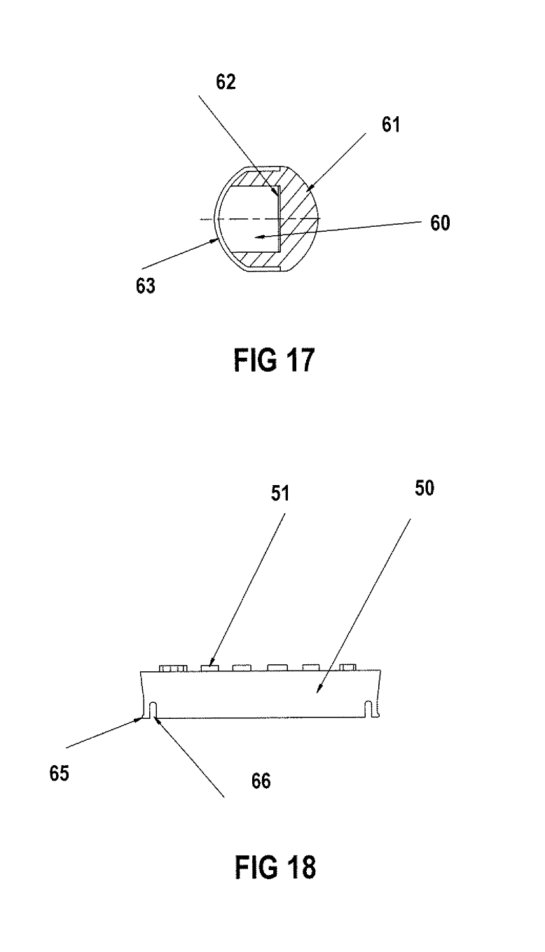

FIG. 17 is a cross-section of the handle 3 at the section having the picture insert 62 in which the soft rubber-like material 63 wraps around a part of the handle for gripping or aesthetic purposes. The plastic insert 60 may be clear to permit light to enter on the back side of the picture. In the embodiment shown, the handle 3 has a convex 61 shape to it.

FIG. 18 illustrates an alternate embodiment for the insert 50 with, e.g., raised lettering 51 on it, where the bottom portion of the insert 50 has a latching mechanism 65 that permits the insert to grip the handle 3 with a correspondingly shaped receiving portion of the pocket (not shown) to ensure that the insert 50 does not fall out. In the embodiment illustrated, the protrusion 65 on the tabbed portion is pressed inward during insertion, which is permitted by adjacent gaps 66 in the insert 50. When the insert 50 is in place in the handle 3, the protrusions flex out to hold the insert 50 in place.

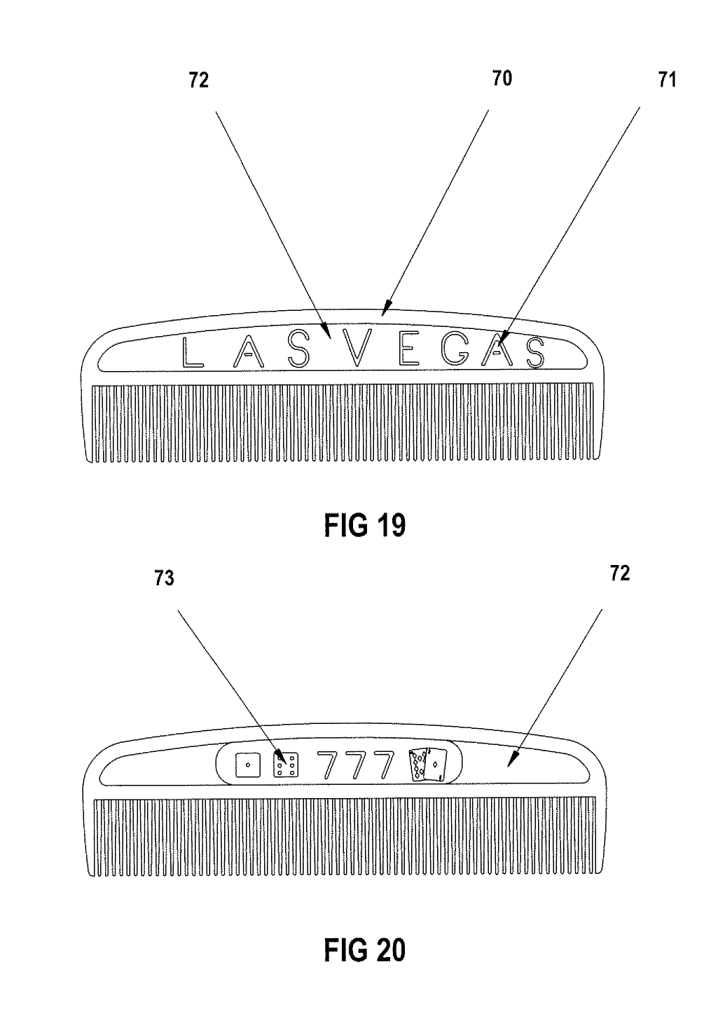

FIGS. 19 and 20 illustrate embodiments of the invention that are applied to a souvenir comb 70. In this embodiment, the molded letters 71 are formed in a similar manner to those shown in FIG. 2 for the toothbrush, and may be surrounded by a soft rubber-like material or possibly a clear material 72. FIG. 20 represents an embodiment similar to that shown in FIG. 19, except that a graphical picture 73 is inserted. Alternately, it is possible that FIG. 20 reflects an opposite side of the same comb 70 shown in FIG. 19. An insert may be utilized to provide the molded letters 71 and/or the graphical picture 73.

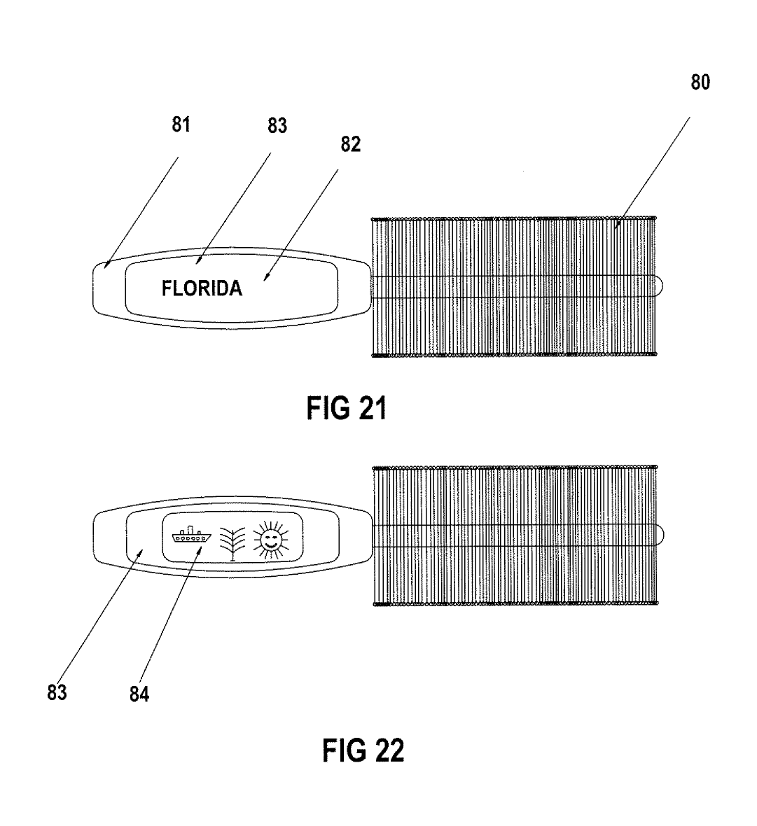

Similarly, an embodiment applied to a souvenir hair brush 80 is illustrated in FIGS. 21 and 22. FIG. 21 shows a brush 80 having a handle 81 in which molded letters 82 are formed in a similar manner to those shown in FIG. 2 for the toothbrush, and may be surrounded by a soft rubber-like material or possibly a clear material 83. FIG. 22 represents an embodiment similar to that shown in FIG. 21, except that a graphical picture 84 is inserted. Alternately, it is possible that FIG. 22 reflects an opposite side of the same brush 80 shown in FIG. 21. An insert may be utilized to provide the molded rubberlike material 83 and/or the graphical picture 84.

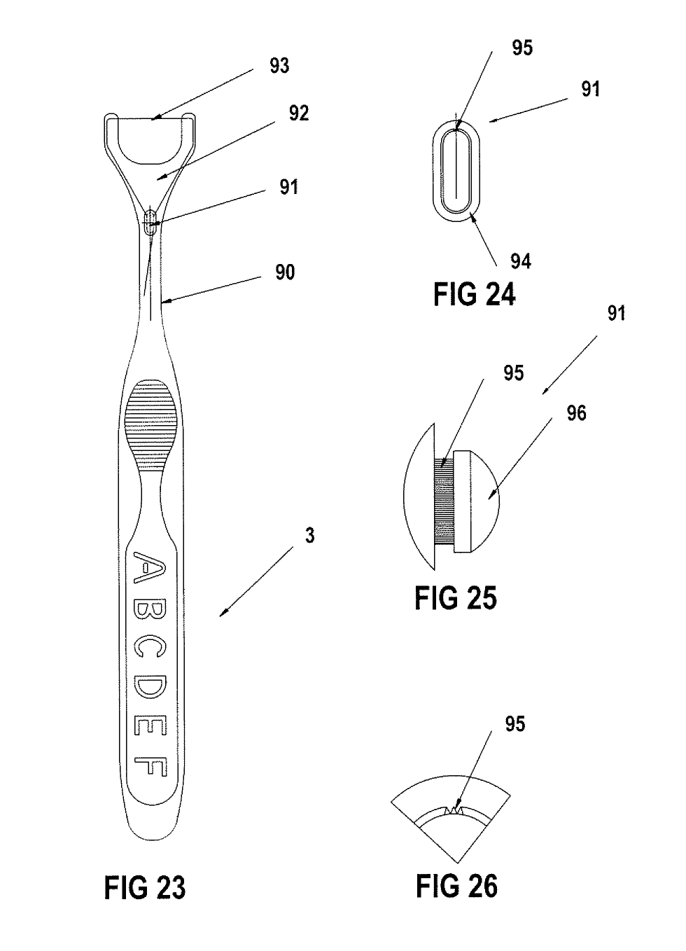

FIGS. 23-26 illustrate embodiments of the invention that are applied to a souvenir flosser 90. The handle 3 is similarly constructed to the handle of the toothbrush embodiment illustrated in FIGS. 1-18. Additionally, the flosser has a head region 92 comprising the floss 93 itself, as well as a knob 91 used to hold the floss taught. FIG. 24 shows the knob 91 comprising a floss wrapping area 94 as well as friction teeth 95 for floss retention (also shown enlarged in FIG. 26). FIG. 25 illustrates a side view of the knob 91 having a capping portion 96 that covers the friction teeth 95.

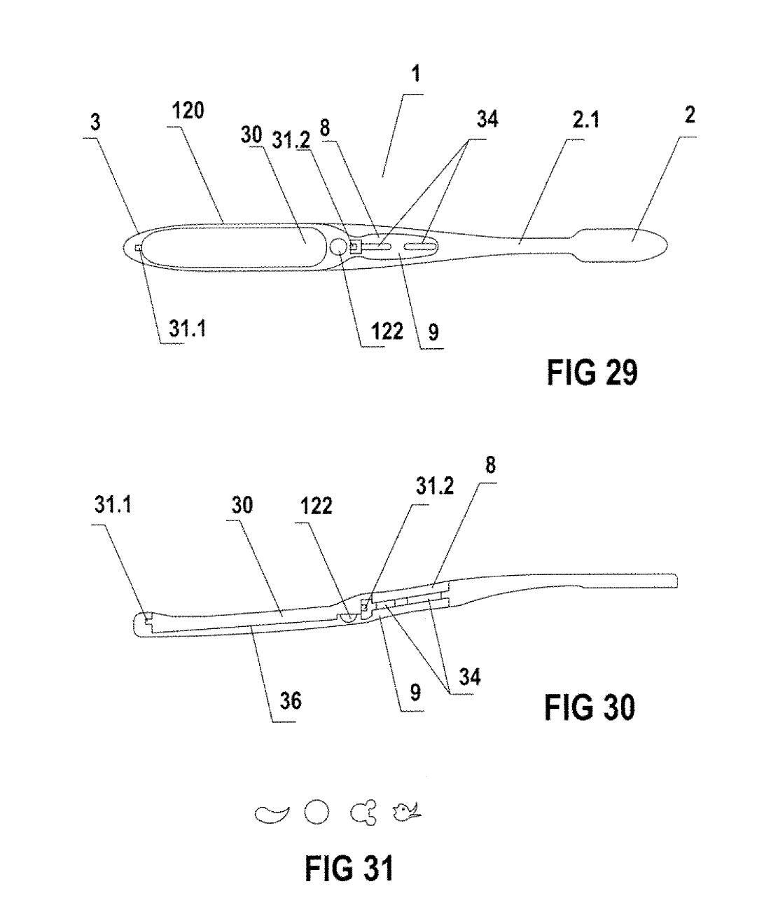

A further advantageous embodiment is illustrated in FIGS. 29-37. FIGS. 29-32 are top and side views of the toothbrush handle 1 after a first molding operation. As can be seen, the basic components include a head portion 2, a neck portion 2.1, a grip portion 120, and a tail portion 3. A window 30 is created in the grip part of the toothbrush handle 1 for later placement of a picture insert 6 (FIG. 33).

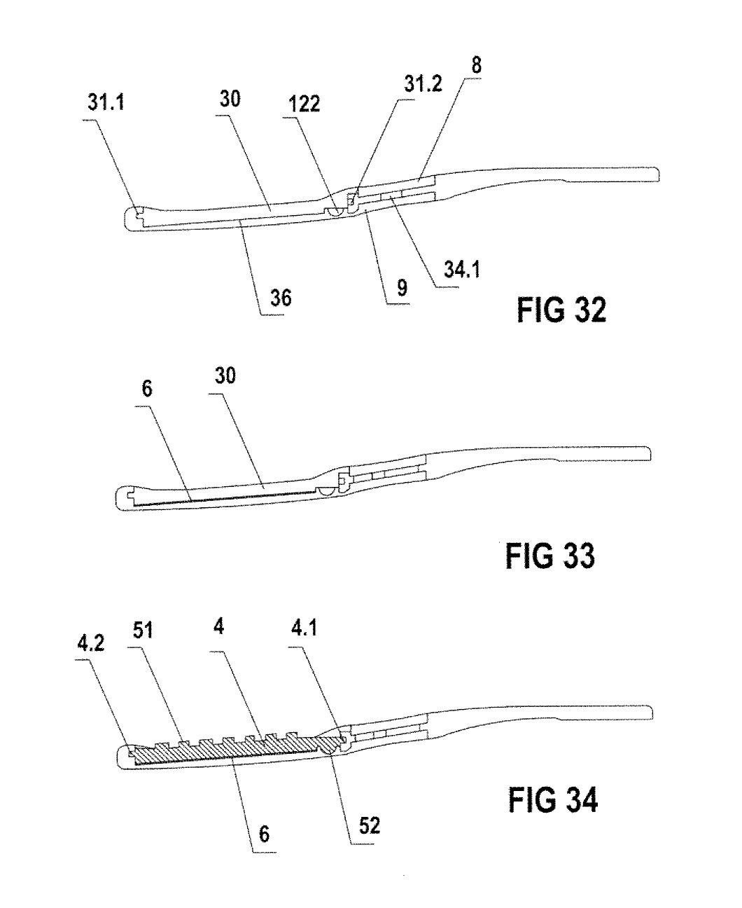

A top pocket 8 and bottom pocket 9 are provided for holding thermoplastic elastomer material is provided in the grip portion of the toothbrush handle 1. FIG. 29 illustrates two windows 34 between the top 8 and bottom 9 pocket through which the thermoplastic elastomer can pass in a subsequent step of applying the thermoplastic elastomer to the handle 1. In an alternate embodiment shown in FIG. 32, a single window or gap 34.1 is provided—in these embodiments, the actual number of gaps or windows is not important, as long as a mechanism is provided for conveying the thermoplastic material from the top pocket 8 to the bottom pocket 9, or vise versa. Note that these windows 34, 34.1 can serve as the conduit for the filling of the thermoplastic elastomer to all regions of the handle.

A logo pocket 122 may be provided in which a three-dimensional shape of a company's logo or trade mark may be subsequently provided. This shape is then subsequently filled with plastic of different colors on the second molding operation. FIG. 31 provides some exemplary logos or trademarks that could be inserted into the logo pocket 122.

A tail catch pocket or recess 31.1 may be provided in the tail 3 of the handle, and a distil catch pocket or recess 31.2 may further be provided in order to provide a secure retention of an insert 4 (FIG. 34) to be subsequently inserted into the main pocket 30. A bottom pocket portion 36 of the pocket 30 is provided to support a placement of a picture insert 6 (FIG. 33).

In order to firmly secure the picture insert 6 into the handle pocket 30, a flexible insert 4, preferably made of molded plastic, is provided, as shown in FIG. 34. The insert 4 may have securing mechanisms in the form of a tail end protrusion 4.2 and distal end protrusion 4.1 that fit into the tail end and distal end catch pocket or recess areas 31.1 and 31.2 respectively. Although the molded plastic insert 4 may be formed separately and then subsequently inserted into the main handle pocket 30, in an advantageous embodiment of the invention, the insert 4 is directly molded into the pocket 30 so as to completely fill any holes or gaps (which is not possible in the case of the separately formed and placed insert 4). A further chemical adhesion may be applied to enhance the mechanical retention of the insert 4 into the pocket 30. Such an approach can decrease the cost of manufacturing and permit a better sealing of the pocket 30 to prevent moisture or other contaminants from damaging the picture insert 6.

The insert 4 has a bottom surface that faces the picture insert 6 and a top surface that may contain a raised portion 51. The insert 4 may further contain the company logo 52 that completely or partially fills the pocket 122 of the handle 1 described above. With this design, both the picture on the picture insert 6 and the company logo 52 may be seen through the clear plastic of the handle 1.

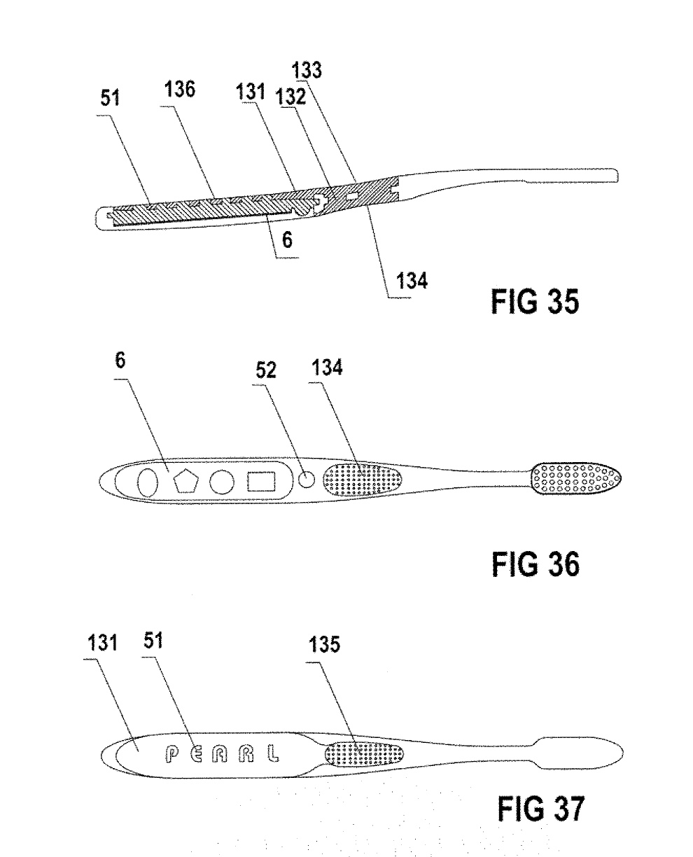

In a subsequent step illustrated in FIGS. 35-37, a thermoplastic elastomer material is provided over the molded plastic insert 4. This fills 131 the gap by the logo portion 52 of the insert 4, fills the windows/gaps 34, 34.1 for passing thermoplastic elastomer material from the top portion of the toothbrush to bottom part of the toothbrush handle in the grip area, and fills the top pocket 8 and the bottom pocket 9 of the handle 1 in the grip area. This filling 136 in the region of the raised portions 51 of the insert are preferably done to the same height as the raised portions 51 to provide a smooth and continuous surface that is structurally sound (with no protrusions (subject to excessive wear) or recesses (subject to a filling of dirt and grime)) and aesthetically pleasing. In this manner, it is possible to form the elastomeric material as a single piece, and this can optimally be present on the top and bottom surface of the handle.

This elastomeric filling provides a further advantageous sealing function that additionally protects the picture insert 6 or other contents of the pocket 30 from external contaminants.

In the situation where the insert 4 and the elastomer material 131 are of different colors, a clear contrast exists for seeing the raised portions 51 of the insert as a part of the handle design. Furthermore, the elastomer material 131 may be formed so as to create a generally coherent and uniform surface with no substantial discontinuities, so as to be structurally sound and aesthetically pleasing.

FIG. 36 illustrates a completely molded toothbrush handle from the bristles side of the toothbrush handle. The picture insert 6 is visible through the clear window of the pocket 30 of the toothbrush handle 1. The company logo 52 is also visible from the bristle side of the toothbrush handle. The thermoplastic elastomeric material 134 in the thumb grip area can further be seen.

FIG. 37 illustrates this completely molded toothbrush handle from the logo side opposite bristles side of the toothbrush handle 1. The thermoplastic elastomeric material 135 in the thumb grip area can further be seen on this opposite side, as can the raised portions 51 of the insert surrounded by the elastomeric filling 136. The lettering in such raised portions 51 as illustrated in FIG. 37 can have gaps to facilitate a filling of the letter pocket areas with the elastomeric material during formation.

It should be noted that although the use of the insert 4 provides certain advantages, when costs are a concern, the insert 4 can be dispensed with. In other words, the thermoplastic elastomeric material can be used to completely seal the pocket 30 containing the picture insert 6 and contacts the picture insert 6 to similarly form a smooth and aesthetically pleasing handle 1. In both variants, the one with and the one without the insert 4, the elastomeric material, by being a part of the molding process and contacting the remaining portion of the handle, forms a much tighter seal for the pocket than was previously possible. Although a partial filling with the elastomeric material is possible for the seal, in a preferred embodiment, the seal is achieved by generally filling all gaps or spaces inside the image pocket.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The particular implementations shown and described herein are illustrative examples of the invention and are not intended to otherwise limit the scope of the invention in any way.

For the sake of brevity, conventional aspects (and components) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A toiletry article comprising:
a head portion comprising an operational end that operatively interacts with a user;
a handle part comprising a thermoplastic material and further comprising an image pocket;
an image insert comprising text or an image on one or both sides that is located within the image pocket;
a pocket insert separate from the image insert located inside of the image pocket on top of the image insert; and
a soft rubber-like material molded to the handle that completely seals the image pocket.

2. The toiletry article according to claim 1, wherein the image insert is flat.

3. The toiletry article according to claim 1, wherein the pocket insert is made of a clear material.

4. The toiletry article according to claim 17 wherein the soft rubber-like material is a thermoplastic elastomer (TPE).

5. The toiletry article according to claim 1, wherein the handle comprises a clear thermoplastic material

6. The toiletry article according to claim 1, further comprising:
rib pockets comprising soft rubber-like material pieces configures as ribs;
a gap between top and bottom portions of the article handle to serve as a passage for soft rubber-like material; and
a gate pocket for soft rubber-like material with its bottom placed above and on a side from the bottom of the image pocket.

7. The toiletry article according to claim 1, further comprising:
rib pockets comprising soft rubber-like material pieces configures as ribs; and
a gate pocket for soft rubber-like material with its bottom placed above and on a side from the bottom of the image pocket.

8. The toiletry article according to claim 1, wherein the image pocket has a defined shape, and the image insert and pocket insert have the same defined corresponding shape.

9. The toiletry article according to claim 1, wherein the handle part comprises a clear thermoplastic material and has a shape selected from the group consisting of: a bottom flat cross-sectional shape, a bottom concave cross-sectional shape, and a bottom convex cross-sectional shape.

10. The toiletry article according to claim 1, wherein the pocket insert comprises text or an image, and various interchangeable pocket inserts with differing text or images can be placed in the image pocket of the toiletry article, and wherein the text or image on the pocket insert is raised.

11. The toiletry article according to claim 10, wherein the text or image on the pocket insert is surrounded by a soft rubber-like material.

12. The toiletry article according to claim 1, wherein the pocket insert comprises a holding mechanism configured to engage a corresponding holding mechanism in the image pocket to prevent the pocket insert from falling out from the image pocket.

13. The toiletry article according to claim 1, wherein the toiletry article is a toothbrush and the operative end comprises toothbrush bristles.

14. The toiletry article according to claim 1, wherein the toiletry article is a flosser and the operative end comprises taut dental floss.

15. The toiletry article according to claim 1, wherein the toiletry article is a comb and the operative end comprises comb teeth.

16. The toiletry article according to claim 1, wherein the toiletry article is a hair brush and the operative end comprises brush bristles.

17. The toiletry article according to claim 1, wherein the soft rubber-like material and the thermoplastic handle material form a generally smooth and continuous surface.

18. The toiletry article according to claim 1, wherein the pocket insert further comprises a three-dimensional logo or image that is separate from the image provided on the image insert and is viewable through the handle.

19. The toiletry article according to claim 1, wherein the soft rubber-like material comprises a single piece that is located on a top surface and a bottom surface of the handle.

20. The toiletry article according to claim 17 wherein the sealing by the soft rubber-like material is achieved by generally filling in all gaps or spaces of the image pocket with the soft rubber-like material.

21. A method for forming a toiletry article, comprising:
forming a handle part from a thermoplastic material, the handle part comprising an image pocket;
placing an image insert comprising text or an image on one or both sides into the image pocket;
applying a soft rubber-like material that is molded to the handle part to completely seal the image pocket.

22. The method according to claim 21, further comprising:
forming a pocket insert within the image pocket above the image insert prior to applying the soft rubber-like material.

23. The method according to claim 22, further comprising applying an adhesive to affix the pocket insert into the image pocket.

24. The method according to claim 21, wherein applying the soft rubber-like material comprises injecting this material on a top side of the handle and passing this material through a gap or window of the handle so that the material flows to a bottom side of the handle.

25. The method according to claim 21, wherein applying the soft rubber-like material comprises forming a smooth and continuous surface with the soft rubber-like material and the thermoplastic material of the handle.

26. A toiletry article comprising:
a head portion comprising an operational end that operatively interacts with a user;
a handle part comprising a thermoplastic material and further comprising an image pocket;
an image insert comprising text or an image on one or both sides that is located within the image pocket; and
a soft rubber-like material molded to the handle that completely seals the image pocket and contacts the image insert.
